(19) United States
(12) Patent Application Publication
(10) Pub. No.: US 2026/0295960 A1
(43) Pub. Date: Oct. 1, 2026

(54) OPERATING MACHINE

(71) Applicant: BABBINI S.P.A., CIVITELLA DI ROMAGNA (FC) (IT)

(72) Inventors: Ermanno PRATI, Forli (FC) (IT); Gianni BARTOLINI, Forlimpopoli (FC) (IT)

(73) Assignee: BABBINI S.P.A., CIVITELLA DI ROMAGNA (FC) (IT)

(21) Appl. No.: 19/479,799

(22) PCT Filed: Apr. 30, 2024
(86) PCT No.: PCT/IB2024/054172

§ 371 Date: Oct. 29, 2025

(30) Foreign Application Priority Data
May 2, 2023 (IT) 102023000008598

(51) Int. Cl. B30B 9/16; B30B 9/02

(52) U.S. Cl. CPC B30B 9/16; B30B 9/02

(57) ABSTRACT

An operating machine (1) for continuously draining a liquid phase (L) from wet material (MU); the machine comprising a frame (10) that extends along a rectilinear direction (D) oriented in a determined way between a loading station (30) and an unloading station (40); the loading station (30) and the unloading station (40) being connected by an intermediate operating station (50); drainage means (60) of the wet material (MU) being associated with said operating station (50) to progressively drain said material up to said unloading station (40); the drainage means (60) comprising a drainage duct (62) carried by said frame (10) and extending along the direction (D) between the loading station (30) and the unloading station (40); the drainage means (60) comprising a first auger (64) and a second auger (64′) carried by the frame (10) inside the drainage duct (62) in a rotating manner.

### DESCRIPTION

The present invention relates to an operating machine. In particular, the present invention relates to an operating machine usable to drain a liquid phase from wet material. In more detail, the present invention relates to an operating machine usable for continuously draining a liquid phase from wet material.

### DESCRIPTION OF THE PRIOR ART

In the waste or processing scrap treatment sector, the costs of the relative transport and disposal are significant factors that influence particularly the economy of treatment. Below, the terms “waste” and “scrap” will be used interchangeably, other than for appropriate specifications linked to the industrial sector of reference: the term processing scrap is generally used when the material produced following a dehydration treatment is further usable for production purposes, whereas the term waste is used when the dehydrated material is not suitable for use for further production purposes.

Considering that the mass and volumes of waste to be transported impact significantly on the cost of disposal and the means of transport usable and on the relative cost per kilometre, one of the preliminary operations for the waste treatment chain is drainage of the liquid part. Elimination of this phase makes the waste to be treated lighter and more compacted, and therefore less challenging in terms of volume, both to handle and to transport, making the treatment cost decidedly lower.

The methods with which waste drainage is performed are highly diverse, even if treatment is normally performed using machinery that operates continuously in a single passage. Among these machines, operating machines are known that are provided with an auger contained inside a horizontal cylindrical duct arranged between a loading station and an unloading portion and with the respective lower portion provided with a plurality of openings for a first unloading step of the liquid phase through percolation. The duct feeds the waste to a squeezing station in which the waste fed by the auger is pressed in the presence of a reduction in the passage cross-section of the duct. When it is intended to obtain higher percentages of dry matter, the operating machines described above are associated with devices that produce counter-pressure to unloading in an active manner, increasing the cost of the plant.

Furthermore, in machines of the type described above, adhesion of the wet material to the auger occurs frequently. In particular, the wet material being squeezed tends to adhere to the auger on the thrust face of the screw and to the shaft and to rotate rigidly with it, with the result that the hourly flow rate of dehydrated material, and therefore the volume of material being dehydrated advanced towards the unloading station, falls progressively. It is worth specifying that the adhered material tends to erode through rubbing the surfaces to which it adheres (the thrust face of the screw and the outer surface of the shaft), in addition to the crests of the screw and, therefore, the inner surface of the duct that contains the auger, as well as increasing the resistance to rotation of the auger itself. The consequence of this is a reduction of the flow rate of dehydrated material, which is normally counteracted by progressively increasing the speed of rotation of the auger. However, increasing the speed of rotation of the auger results in a higher consumption of electricity, premature deterioration of performance of the motor unit of the auger, greater wear of the surfaces mentioned above and, therefore, an increase in the frequency of maintenance operations and in the respective cost. Therefore, once the adhesion described above is found, it is advisable to halt functioning of the machine and to clean the respective auger. This solution is also accompanied by unfortunate economic impacts, given that it results in halting of operation of the machine, and therefore its productivity, and a consequent increase in the respective period of depreciation.

In order to limit the incidence of adhesion of material to the auger in the food industry, the so-called “twin-screw presses” are used, comprising two augers that can be counter-rotating, or to which the wet material to be treated is fed in the form of pulp that represents the scrap of pulping machines in which a first liquid phase has been continuously separated from agri-food products, including, but not limited to, fruit or vegetables. In the paper manufacturing sector, the portion of “drained matter”, defined as “dry” in certain contexts, treated with a single passage through a single operating machine, represents on average 35%, and is sent to garbage dumps or to waste-to-energy plants, SO this percentage is considered satisfactory for the economic chain of the sector.

In the agri-food products treatment sector, the percentage of juice extracted is obviously maximised, as it is marketed, even if, on average, the dry matter has a mass that is normally approximate to 40% of the mass of wet material.

It is well understood that percentages with these values cannot even halve the mass of scrap or waste extracted from the mass of wet material to be processed, even if the waste and scrap industry is required to comply with sector regulations that are increasingly more focused on the impact on nature of what leaves the product industrial chain to then enter the waste management chain or, preferably, to become a product usable in another production sector.

Based on what is described above, the problem of bringing the percentage of dry matter in waste above 35-40% is currently unsolved, and represents an interesting challenge for the applicant, whose object is obviously to produce draining machines that minimise the impact on nature H scrap and/or waste both directly, through reduction of the masses of treated material for disposal or transfer or supply to another production plant, and indirectly, through reduction of the relative components, and therefore the overall cost of the machine, the energy consumption for the relative production, the costs of the relative logistics, and also with low consumption, prolonged functioning at values close to the project specifications and low maintenance.

In consideration of the situation described above, it would be desirable to have an operating machine to drain the wet material that is practical and economic to use and that, in addition to limiting and possibly overcoming the typical problems of the prior art described above, defines a new quality standard for these types of machines.

### SUMMARY OF THE PRESENT INVENTION

The present invention relates to an operating machine. In particular, the present invention relates to an operating machine usable to drain a liquid phase from wet material.

In more detail, the present invention relates to an operating machine usable for continuously draining a liquid phase from wet material.

The problems indicated above are solved by the present invention in accordance with at least one of the claims that follow.

According to several embodiments of the present invention, an operating machine is implemented for continuously draining a liquid phase from wet material; said machine comprising a frame extending along a rectilinear direction oriented in a determined way between a loading station of said wet material and an unloading station of drained material; said loading station and said unloading station being connected by an intermediate operating station; drainage means of said wet material being associated with said operating station to progressively drain said material up to said unloading station; said drainage means comprising a drainage duct carried by said frame and extending along said direction between said loading station and said unloading station; said drainage means comprising a first auger and a second auger carried by said frame inside said drainage duct in a rotating manner; a coefficient of compression associated with said drainage means having a variable value proceeding from said loading station to said unloading station according to a graph that can comprise, individually or in combination, an increasing or decreasing linear section, a downward facing concave section, an upward facing concave section, at least one inflection point on the basis of said wet material to be treated.

According to an embodiment as described above, said frame supports a plurality of ribs distributed between said loading station and said unloading station; each said rib having a housing shaped to mate with said drainage duct to exert a containment action along said direction; a first rib of said plurality of ribs facing said unloading station carrying modular thrust bearing means, arranged to produce a determined degree of pressure on said drained material fed to said unloading station in output from said duct, so that it has dry matter in a determined percentage.

According to an embodiment as described above, said thrust bearing means are carried by said first rib facing said unloading station and comprise a plurality of plates organized in a sandwich in a number that can be defined as required.

According to an embodiment as described above, at least one of said first and second augers has a wear-resistant treatment carried out by welding.

According to an embodiment as described above, said wear-resistant treatment comprises at least one strip of filler metal of high hardness.

According to an embodiment as described above, said wear-resistant treatment is present on a helical thrust face of each said first and second screws, on the respective crests and on said shaft of each of said first and second augers.

According to an embodiment as described above, said coefficient of compression of said first and second augers is greater than or equal to 2 and less than or equal to 7 or approximates 2.5.

According to an embodiment as described o above, said drainage means are arranged to drain said wet material so as to feed to said unloading station drained material containing dry matter in a percentage ranging from 55% to 75% or in a percentage ranging from 60% to 70% or in a percentage of 65%.

According to an embodiment as described above, said first/second auger is conical and carries a first screw with a variable pitch.

According to an embodiment as described above, said first/second auger is conical with a diameter increasing linearly between said loading station and said unloading station; said first/second screw having a pitch decreasing or increasing between said loading station and said unloading station.

According to an embodiment as described above, said drainage duct comprises at least one plate body having filter means comprising, by choice or in combination, at least one sheet having a plurality of holes of transverse dimension variable in respective length, at least two coupled sheets with coaxial axisymmetric holes and of a different diameter, a plurality of parallel thin plates distributed at reduced distance ranging between 0.1 mm and 1.00 mm.

### BRIEF DESCRIPTION OF THE FIGURES

Further characteristics and advantages of the operating machine according to the present invention will become apparent from the following description, stated with reference to the appended figures, which illustrate at least one example of a non-limiting embodiment, in which identical or corresponding parts of said machine are identified by the same reference numbers. In detail:

FIG. 1 is a schematic perspective view of a preferred embodiment of an operating machine according to the present invention;

FIG. 2 shows FIG. 1 with parts removed for clarity;

FIG. 3 shows FIG. 1 in lateral and cross-sectioned elevation with a longitudinal vertical plane;

FIG. 4a is a view from below of a left-hand end portion of FIG. 2 with parts removed for clarity;

FIG. 4b is a view from below of a right-hand end portion of FIG. 2 with parts removed for clarity;

FIG. 5 is a plan view of two details partially visible in FIGS. 4a and 4b;

FIG. 6 is a schematic perspective view on an enlarged scale of a portion of FIG. 2 with parts removed for clarity;

FIG. 7 is a schematic perspective view of two details partially visible in FIG. 6;

FIG. 8 is a schematic perspective view of FIG. 6 on an enlarged scale of a portion of FIG. 6;

FIG. 9 shows a detail of FIG. 8 in two views, respectively rear and front;

FIG. 10 is a schematic three-dimensional view of a detail extracted from FIG. 2 on an enlarged scale and with parts removed for clarity;

FIG. 11 is a diagram that shows the graphs relating to the value of a coefficient correlated to the geometry of a device of FIG. 1 expressed as a function of the distance from a station of the machine;

FIG. 12 is a schematic perspective view of a variant of a structural component visible in FIGS. 6 and 8 with parts removed for clarity;

FIG. 13 shows FIG. 12 from a different viewpoint on an enlarged scale and with parts removed for clarity.

### DETAILED DESCRIPTION OF THE PRESENT INVENTION

Before describing in detail the preferred embodiments of the present invention or details of it, it is considered useful to specify that the relative scope of protection is not limited to the particular embodiments described here below. The disclosure and description in this document are illustrative and explanatory of one or more currently preferred embodiments and variants, and it will be clear to people skilled in the art that various changes in the design, in the organisation, in the order of operation, in the operating means, in the structures of the equipment and position, in the method and use of mechanical equivalents could be made without being extraneous to the spirit of the invention.

Furthermore, it must be understood that the purpose of the appended figures is to illustrate and clearly disclose currently preferred embodiments to one of the people skilled in the art, but that they are not drawings that illustrate how such embodiments should be performed in reality or actual representations of end products; on the contrary, these figures could comprise simplified conceptual views to facilitate understanding or to allow an easier and rapid explanation be provided.

Furthermore, the dimensions and the arrangement of the components could differ from the ones shown and still function in the spirit of the invention.

In any case, it will be clear that various directions, such as “upper”, “lower”, “left”, “right”, “front”, “rear” and so on, are performed only with respect to the explanation, in combination with the drawings, and that the components could be oriented in a different way, for example during transport and production, and also during functioning. Since many different and separate embodiments could be made within the scope of the concepts taught here, and since there are multiple changes that could be made to the embodiments described here, it must be understood that the details provided below should be interpreted as illustrative and not limiting the spirit of the invention.

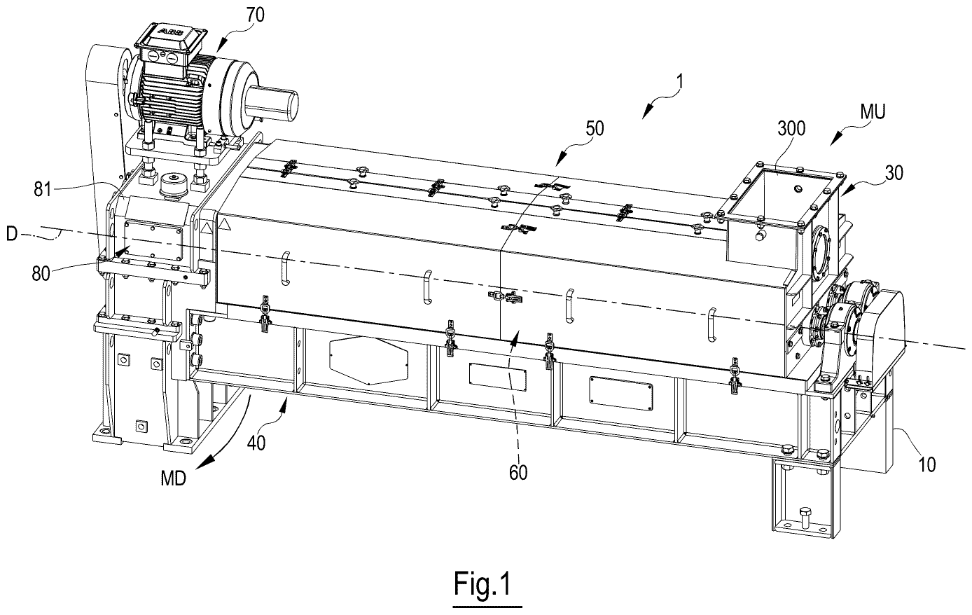

In FIG. 1, the number 1 indicates, as a whole, an operating machine 1 usable for continuously draining a liquid phase L from wet material MU that can be destined for a subsequent processing or be used as waste to be requalified. The machine comprises a frame 10 that extends along a rectilinear direction D oriented in a determined way between a loading station 30 and an unloading station 40 of drained material MD. In the appended figures, the direction D is oriented horizontally when the machine 1 is in use, without this feature having to be considered as a limitation for the technical solution to which this patent application relates, given that said machine could be interchangeably structured so that said direction is vertical or inclined.

Again with reference to FIG. 1, the loading station 30 and unloading station 40 are connected by an intermediate operating station 50. A drainage device 60 of the wet material MU, the function of which is progressively to drain said wet material MU up to the unloading station 40, is associated with this operating station 50.

On the machine according to claim 1, the drainage device 60 comprises a drainage duct 62, or drainage cage, which is supported by the frame 10 and extends along the direction D between the loading station 30 and the unloading station 40. The loading station 30 comprises a hopper 300 usable to feed the wet material MU to be drained to the machine 1. The hopper 300 is in hydraulic communication with the duct 62 and the unloading station 40 has an unloading opening 400 that is in hydraulic communication with the duct 62. As will be better specified below, the duct 62 is provided with unloading members distributed along the respective length.

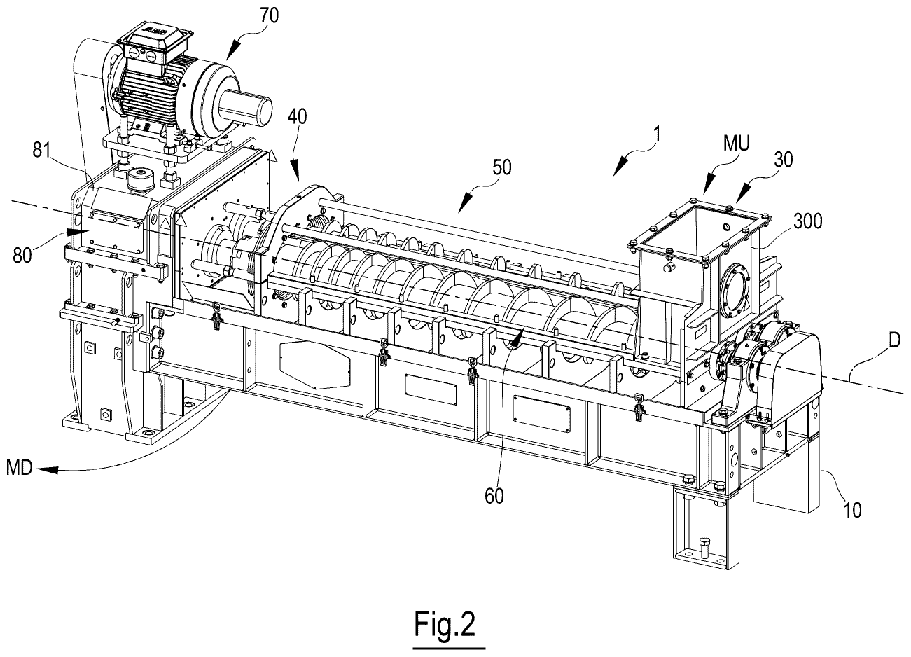

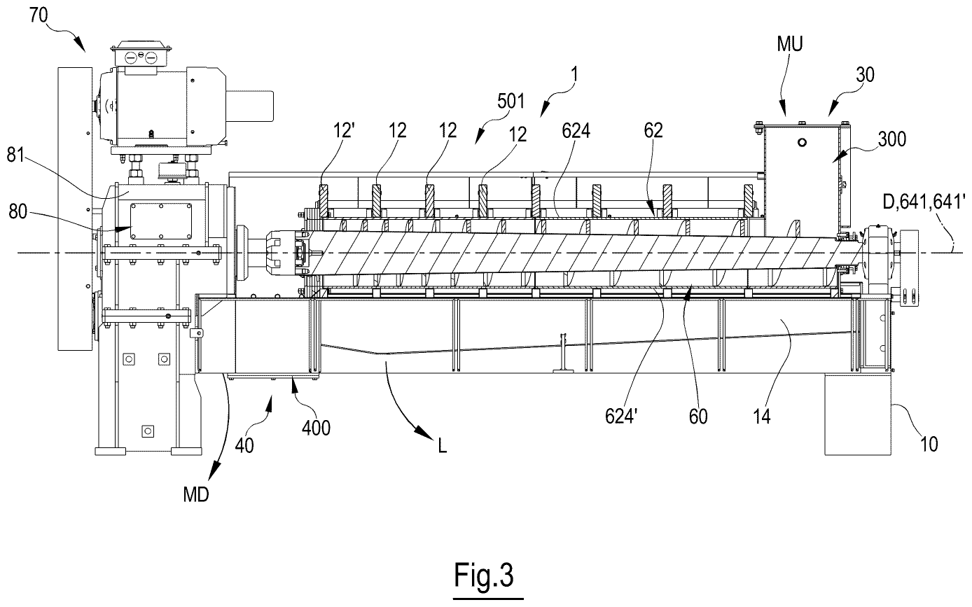

With particular reference to FIGS. 3, 6 and 7, the duct 62 comprises at least one plate body 622 provided with two axisymmetric half-shells 624, each of which is carried by the frame 10. The drainage device 60 further comprises a first auger 64 provided with a first shaft 640 carried by the frame 10 in a rotating manner and arranged inside the half-shells 624. With reference to FIGS. 1-4 and 6, the frame 10 supports an actuating unit 70 that is mechanically connected to the first auger 64, in a known way and not illustrated to save on drawing and description, in order to rotate it around a respective first axis 641 parallel to the direction D at a speed determined as required.

With particular reference to FIGS. 3 and 6, the frame 10 supports a plurality of ribs 12 distributed between the loading station 30 and the unloading station 40; each rib 12 has a housing shaped to mate locally with the duct 62, and in particular with each half-shell 624, for the purpose of exerting a containment action along the direction D when, in use, the wet material MU is advanced by the first auger 64 from the hopper 300 to the unloading opening 400.

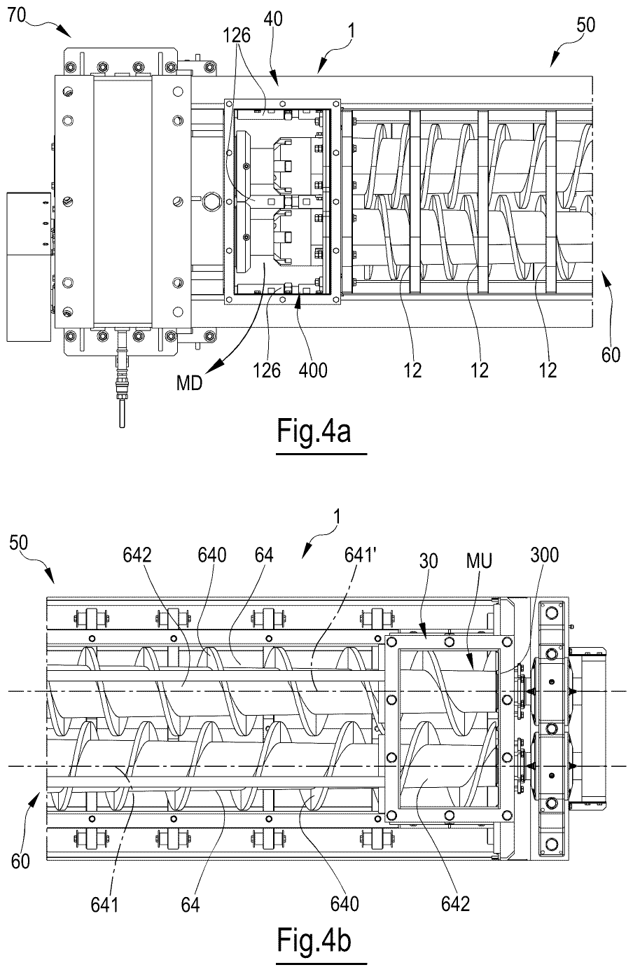

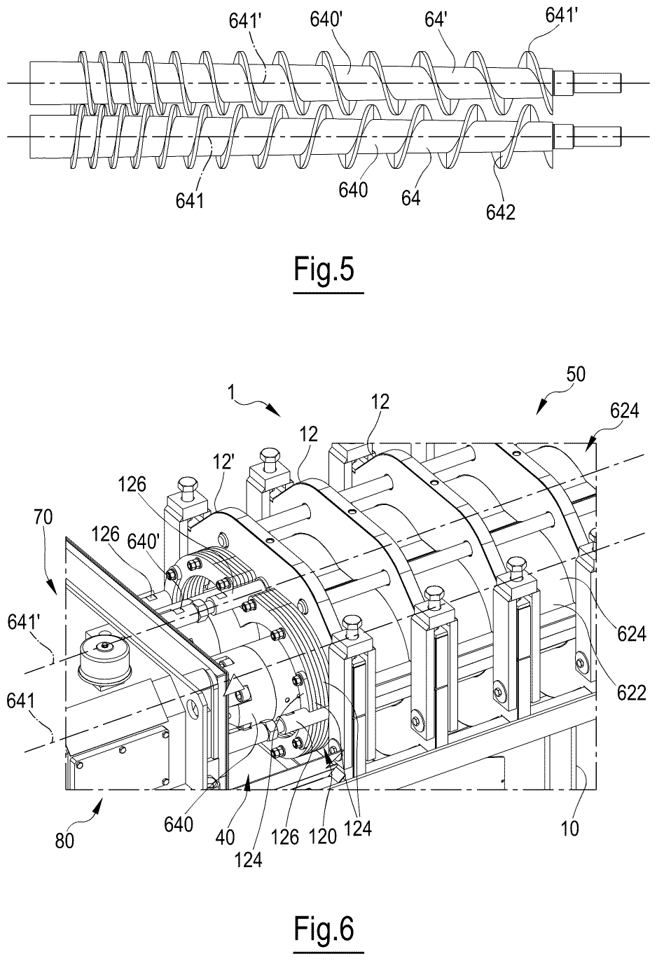

With reference to FIGS. 4a, 4b and 5, but without limiting the scope of this invention, the first auger 64 is conical and carries a first screw 642. In particular, the conical shape of the first auger 64 has a diameter increasing linearly and in particular the respective pitch is variable, decreasing travelling the direction D between the loading station 30 and the unloading station 40.

In addition, it is useful to specify that a quantity called “coefficient of compression” is associated with the first auger 64, which is calculated as the ratio between an initial volume, calculated in relation to the portion of the first auger 64 immediately adjacent to the loading station 30, and a final volume calculated in relation to the portion of the first auger 64 immediately adjacent to the unloading station 40, each of which is easily determinable if the dimensional characteristics of the first auger 64 are known, in particular the outer diameter of the respective first screw 642, the diameter of the shaft 640 that carries the screw and the inner diameter of the half-shells 624. Said coefficient, which is equal to 1 in cylindrical augers with a constant pitch, is characteristic of the drainage device 60 and, according to the tests performed by the applicant, is to be proportioned as required with conical augers or with an outer profile of another shape in a range comprised between 2 and 7, preferably between 2.5 and 4.5, based on the nature of the wet material MU to be treated and the respective percentage in dry matter.

In particular, the drainage device 60, more specifically the duct 62, is arranged to drain the wet material MU so as to feed to the unloading station 40 the drained material MD containing dry matter in a percentage comprised between 55% and 75%, preferably in a percentage comprised between 60% and 70% or higher than 65%, based on the specific requirements of customers. Therefore, in any case, based on the comparison with the performance of the best-performing twin-screw machines, it can be stated that the machine 1 is suitable for performing a hyper-pressing process on the wet material MU fed to the hopper 300, which allows an average doubling of the relative pressing ratio.

With reference to FIGS. 1-3, the machine 1 comprises a control device 80 carried by the frame 10 inside a casing 81 that contains the drainage device 60 and is electrically connected to the actuating unit 70 to command rotation of the first auger 64 so as to define as required the rotation speed and the respective variations in speed in time (acceleration) instant by instant.

With particular reference to FIGS. 6, 8 and 9, the drainage device 60 comprises a thrust bearing member 120 carried by a first rib 12′ of the plurality of ribs 12 (therefore by the frame 10 and facing the unloading station 40). Said thrust bearing member is arranged to produce a coefficient of compression determined on the drained material MD fed to said unloading station 40, therefore at the end position of the first and second augers 64 and 64′ exiting from the duct 62, so that said drained material MD has dry matter in a determined percentage.

In particular, in use the first rib 12′ is facing the unloading station 40 and axially delimits the unloading opening 400. In turn, the thrust bearing member 120 comprises a plurality of plates 124 organised in a sandwich in a number that can be defined as required, which are maintained packed together by means of respective screw members. The number of plates 124 can be defined as required, given that the assembly on the first rib 12′ is performed by means of threaded screws and, thus, is determinable based on the specific operating needs and freely changeable as needed.

The first auger 64 has a wear-resistant treatment performed on the respective first screw 642, in particular at least on the respective crest, on the respective helical thrust face that looks towards the unloading station 40 and on the free surface of the respective shaft 640. The wear-resistant treatment can be performed in any way on the first screw 642 and on the shaft 640 upstream of the installation or also on said components downstream of said installation, and thus on all or several of the construction elements of said first auger 64. In this case, without limiting the scope of the present invention, the wear-resistant treatment can be carried out by the addition of a metal or a metal alloy or any other material having a hardness greater than that O 4 the material or of the materials with which the shaft 640 and the first screw 642 are fabricated. Furthermore, the wear-resistant treatment can be performed by applying the strips 646 illustrated schematically in FIG. 10, where said strips are applied adjacent on the thrust surface of the first screw 642 and on the shaft 640, whereas only one of them is applied on the crest 645 of the first screw 642 to delimit it peripherally. Application of the strips 646 may be performed by means of welding and it is opportune to specify that said strips are illustrated in particularly accentuated width and thickness in FIG. 10 for practical drawing, but can have a different shape, proportions and dimensions, based on design requirements.

It is easy to understand that this type of wear-resistant treatment is practical to apply and produces a considerable saving from multiple viewpoints: minimal adhesion of the partially drained material to the outer surface of the various surfaces of the first auger 64, hourly volume of drained material always around the figure declared in the operating specifications of the machine 1, lower consumption of electricity due to limitation of the power required for rotation of the first auger 64, always close to the one declared in the operating specifications, minimal impact of maintenance interventions on the components of the drainage device 60 in terms of cost and frequency, and compliance with the times envisaged for depreciation of purchase of the machine.

The drainage device 60 comprises a second auger 64′ positioned alongside the first auger 64 and contained inside the duct 62 and, in particular, delimited radially along the length by two half-shells 624. The duct 62 therefore has respective half-shells 624 of the plate body 626 associated with the frame 10 so as to give the duct 62 an “8” shape in the transverse section. The second auger 64′ is provided with a second shaft 640′ that is carried by the frame 10 in a rotating manner and the actuating unit 70 is mechanically connected to the second auger 64′ to rotate it around a respective second fulcrum axis 641′ that is parallel to the first axis 641 in a clockwise or anti-clockwise direction based on specific needs.

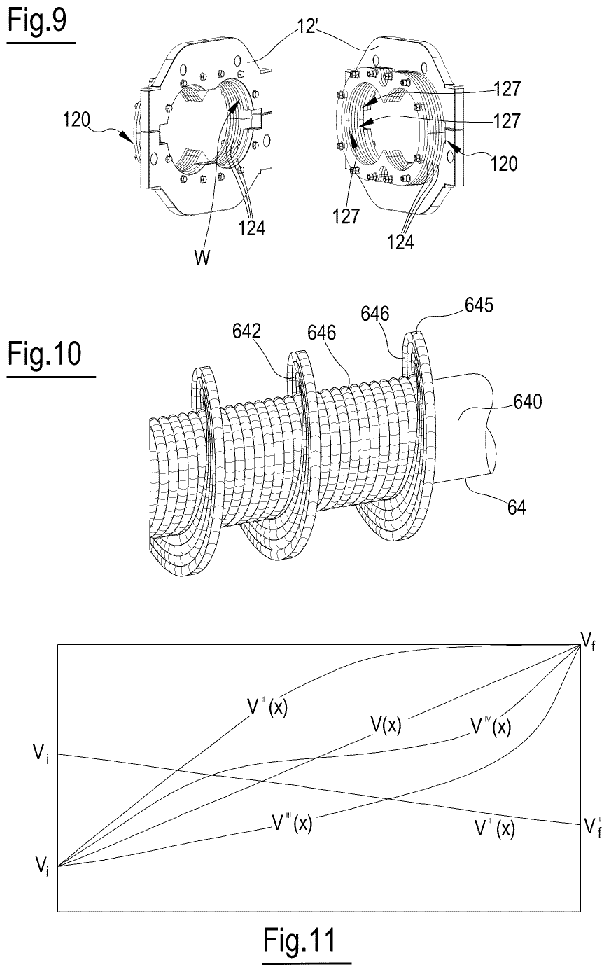

With particular reference to FIGS. 8 and 9, each plate 124 has an opening 127, shaped substantially in an “8”, crossed by the head portions of the first and second augers 64, and has an identical breadth for all the plates 124. The openings 127 of the plates 124 are identical in shape and dimension, so that globally the thrust bearing member 120 is delimited internally by a wall W profiled longitudinally in a parallel manner to the direction D.

Based on what is described above, the wall W is smooth, without thus deviating from the scope of protection of the present invention.

Based on what is described above, the machine 1 may be defined as a twin-screw press for wet material.

The second auger 64′ is identical to the first auger 64 and has a second screw 642′. In particular, but without thus limiting the scope of the present invention, the actuating unit 70 is mechanically connected to the second auger 64′ and the control device 80 may determine its axial rotation both in phase and in counter-phase, therefore counter-rotating, with respect to the first auger 64, based on specific needs.

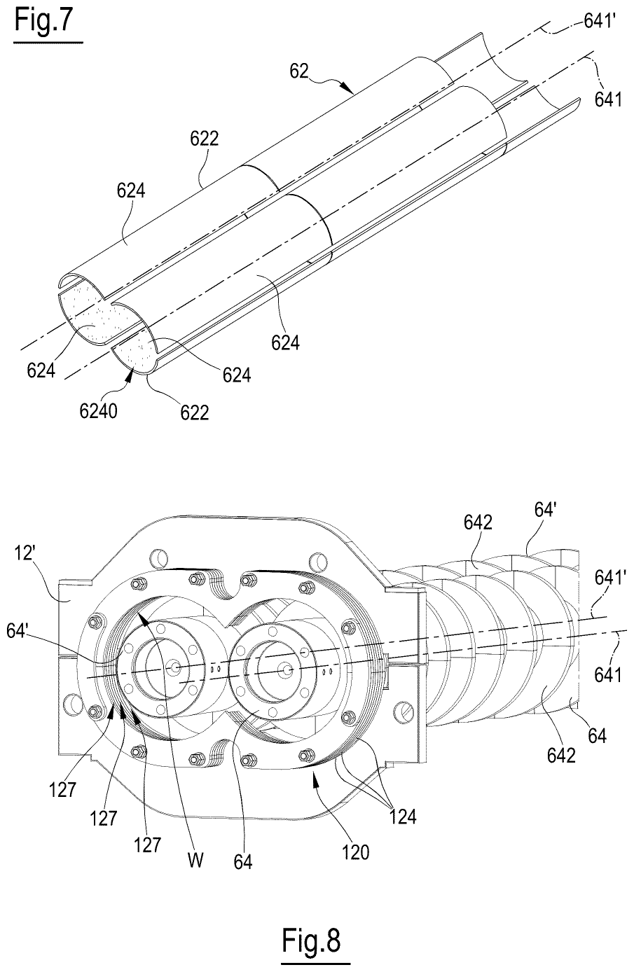

With reference to FIG. 7, each of the half-shells 624 has an axisymmetric shape coaxial to the respective first or second axis 641, 641′ and is shaped so as to have a diameter that longitudinally approximates upwards a local diameter of the first or second screw 642, 642′.

With particular reference to FIG. 3, a first half-shell 624′ of the half-shells 624 is arranged below the first and second augers 64, 64′ and the frame 10 carries a collection tank 14 for the liquid L drained longitudinally from the wet material MU below the first half-shell 624′.

With particular reference to FIG. 7, each half-shell 624 has a cylindrical shape and the half-shells 624 of a first plate body 622′, of at least one of the two plate bodies 622, have unloading members 6240 distributed for the respective length, formed of discontinuities apt to create filtering means. Said unloading members 6240 comprise, by choice or in combination, at least one sheet having a plurality of holes of transverse dimension variable in respective length, or at least two coupled sheets having a plurality of coaxial axisymmetric holes and of a different diameter, or a body defined by a plurality of parallel thin plates connected to each other transversely and distributed at reduced distance ranging between 0.1 mm and 1.00 mm. To save on drawing, it has been decided not to illustrate said unloading members 6240, and only their position is identified in FIG. 7.

What is described above also naturally applies if the wet material MU is formed of paper mill scrap, with the advantage that performing its drainage with a machine that is constructed like the machine 1 makes it possible to maximise the degree of drainage of the wet material, and therefore to recover at least a part of the dry matter for subsequent processing, and to minimise the dry matter to be treated as waste.

Use of the operating machine 1 is easily understandable from what is illustrated above and does not require further explanations. However, it could be useful to specify that, following studies performed by the applicant, it has been possible to observe that, with the same coefficient of compression of the drainage device 60, different materials MU to be drained with the machine 1 release the liquid contained in a different way and in different quantities along the path that goes from the loading station 30 to the unloading station 40, depending on the law of variation of the local volume of the auger between the loading station 30 and the unloading station 40. This circumstance therefore conditions the value of the dry matter collectible in the unloading station 40. To summarise what is expressed above, the release of liquid by the material MU is a function V(X) of the distance from the loading station 30, where said function is correlated to the geometry of the drainage device 60, therefore of each auger, assuming that the half-shells 624 of the respective duct 62 that delimit it have a diameter that, point by point, approximates upwards the local diameter of the crests of the screw, for the sole purpose of preventing reciprocal contact. In further detail, a different graph of the coefficient of compression variable in relation to the different dimension of each transverse section of the duct 62 can be associated with each combination of first auger 64, second auger 64′ and respective duct 62, therefore as a function of the distance x of said section from the loading station 30.

Furthermore, it could be useful to specify that, as can be seen in FIG. 8, the thrust bearing member 120 is carried by the frame 10 facing the unloading station 40 and the plates 124 are equal in shape and dimension. From a structural viewpoint, the plates 124 are maintained packed together against the first rib 12′ by means of the cylindrical thrust members 126 visible in FIG. 4 and in FIG. 6 so as to counteract the thrust that, in use, is exerted by the first auger 64 and by the second auger 64′ on the wet material MU advanced and, consequently, on the thrust bearing member 120 and, in conclusion, on the first rib 12′. Therefore, it can be stated that the thrust bearing member 120 is a drainage concentrating member, and therefore locally determine a determined variation of the concentration of dry matter in the wet material MU, thus a specific value of concentration of the dry matter contained in the wet material MU processed by the machine 1 between the loading station 30 and the unloading station 40, which adds the increment given by said first auger 64 and second auger 64′, due to the specific dimensions of the duct 62 (and of the first and second augers 64 and 64′).

In particular, based on the type of wet material MU to be processed, it could be chosen to install on the machine 1 augers in which the function V(x) is developed by proceeding from the loading station 30 to the unloading station 40 with graphs that, with reference to FIG. 11, comprise, individually or in combination, at least an increasing or decreasing linear section (curves V(x) and Vⁱ(X)), a downward facing concave section (curve Vⁱⁱ(x)), an upward facing concave section (curve Vⁱⁱⁱ(x)), a curved section that has at least one inflection point (curve V^{iv}(x)).

In conclusion, it is clear that changes and variants may be made to the machine described and illustrated here without thus deviating from the scope of protection of the present invention.

For example, it could be useful to construct the duct 62 with a cylindrical or conical shape, not illustrated to save on drawing in the appended figures, in particular with the half-shells 624 with transverse section to their own longitudinal axis, which remains constant or decreases proceeding from the loading station 30 to the unloading station 40. In the case in which the conformations of the duct 62 and of the first and second augers 64 and 64′ contained in it are such that the breadth of the free transverse sections for passage of the wet material MU decreases inside the duct 62 proceeding longitudinally from the loading station 30 to the unloading station 40, the effect is to gradually increase pressure on the material to be drained. This effect is naturally maximum in the case in which the transverse sections of the duct 62 and of each auger decrease and increase proceeding from the loading station 30 to the unloading station 40.

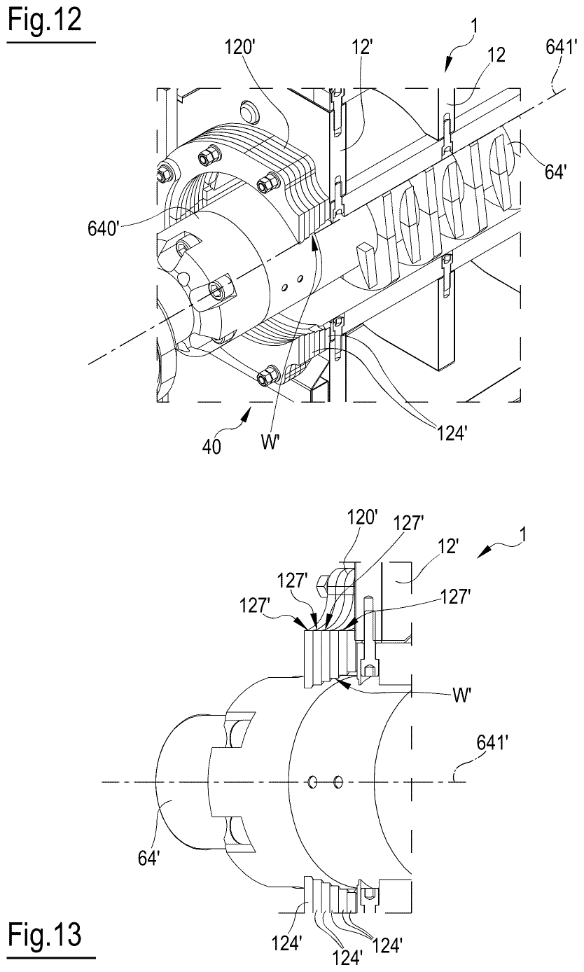

Furthermore, in order to maximise the increment of the contribution given by the coefficient of compression, and to give the thrust bearing member 120 the mechanical characteristic of producing a peak in the capacity to drain liquid exiting the duct 62, the thrust bearing member 120 has been changed to the thrust bearing member 120′, which is delimited internally by a wall W′ produced by a plurality of plates 124′, the number of which is definable as required and the longitudinal profile of which has a decreasing section, as can be seen in FIGS. 12 and 13, where, to save on drawing, only the portion comprising the auger 64′ is shown. In particular, each plate 124′ is delimited by an opening 127′ profiled on the basis of specific operating needs and, in FIGS. 12 and 13, decreasing longitudinally proceeding from the first rib 12′ to the unloading station 40. In FIGS. 12 and 13, the profile of the wall W′ is not linear, conical and in steps, without thus limiting the scope of the present invention. Naturally, the steps could be bevelled to make the wall W′ smooth if the design indications require this, just as the variations in breadth of the openings 127′ could create a wall W′ with a non-linear progress, or the thrust bearing member 120′ could be monolithic and all these variants and those that could be conceived by identifying a specific progress of profiling of the wall W′ would fall within the scope of protection of the present invention.

It can be understood well from what is described above that the machine 1 is the result of numerous pressing tests performed on commercially available twin-screw machines and on trial presses used to treat wet materials of a different nature and composition. Proceeding in this manner has made it possible to understand which specifications to give to the respective drainage devices, and therefore to the augers and to the ducts that contain them, in order to reach high coefficients of compression, maximise the percentage of dry matter to the unloading station 40, avoiding overloading the structural components and the motor unit 70 even when the product to be treated comprises or is formed exclusively of paper mill scrap, a sector in which what is described above is of a particularly major value.

In the claims, any sign of reference between brackets should not be interpreted as a limitation of the claim. The words “that comprises” do not exclude the presence of other elements or steps in addition to those listed in a claim. Furthermore, the term “one”, as used in this context, is defined as one or more than one. Furthermore, the use of introductory expressions such as “at least one” and “one or more” in the claims should not be interpreted in the sense that introduction of another claim element identified using the indefinite article “one” limits any claim in which said claim element appears singularly, even when said claim comprises the introductory phrases “one or more” or “at least one” and the indefinite article “one”. The same applies for the use of definite articles. Unless otherwise established, terms such as “first” and “second” are used to arbitrarily distinguish the elements that such terms describe. Consequently, these terms are not necessarily intended to indicate the temporal or other type of priority of these elements. The simple fact that several measurements are stated in reciprocally different claims does not indicate that a combination of these measurements cannot be used to advantage.

1. An operating machine (1) for continuously draining a liquid phase (L) from wet material (MU); said machine comprising a frame (10) extending along a rectilinear direction (D) oriented in a determined way between a loading station (30) of said wet material (MU) and an unloading station (40) of drained material (MD) containing dry matter; said loading station (30) and said unloading station (40) being connected by an intermediate operating station (50); drainage means (60) of said wet material (MU) being associated with said operating station (50) to progressively drain said material up to said unloading station; said drainage means (60) comprising a drainage duct (62) carried by said frame (10) and extending along said direction (D) between said loading station (30) and said unloading station (40); said drainage means (60) comprising a first auger (64) and a second auger (64′) carried by said frame (10) inside said drainage duct (62) in a rotating manner; a coefficient of compression associated with said drainage means (60) having a variable value proceeding from said loading station (30) to said unloading station (40) according to a graph that can comprise, individually or in combination, an increasing or decreasing linear section, a downward facing concave section, an upward facing concave section, at least one inflection point on the basis of said wet material (MU) to be treated; characterised in that said drainage means (60) comprise a concentrating member (120) (120′) of the drainage rigidly carried by said frame (10) facing the said unloading station (40) and shaped to determine locally a specific value of the concentration of dry matter contained in the drained material (MD) fed to said unloading station (40).

2. The machine according to claim 1, characterized in that said concentrating member (120) is facing said unloading station (30) and comprises a plurality of plates (124) organized in a sandwich in a number that can be defined as required and provided with a respective opening (127) so that, globally, said concentrating member (120) (120′) is delimited internally by a wall (W) (W') profiled longitudinally in a parallel manner to said direction (D) or decreasing in steps or in smooth descent towards said unloading station (40).

3. The machine according to claim 1, characterised in that said concentrating member is monolithic and is delimited internally by a wall profiled longitudinally in a parallel manner to said direction (D) or decreasing towards said unloading station (40).

4. The machine according to claim 2, characterised in that said frame (10) supports a plurality of ribs (12) distributed between said loading station (30) and said unloading station (40); each said rib (12) having a housing shaped to mate with said drainage duct (62) to exert a containment action along said direction (D); a first rib (12′) of said plurality of ribs (12) facing said unloading station (40).

5. The machine according to claim 1, characterised in that at least one of said first and second augers (64, 64′) has a wear-resistant treatment carried out by the addition of a metal or a metal alloy or any other material having a hardness greater than that of the material or of the materials with which said at least one of said first and second augers (64, 64′) is fabricated.

6. The machine according to claim 5, characterized in that said wear-resistant treatment is carried out by welding.

7. The machine according to claim 6, characterized in that each of said first and second augers (64, 64′) presents respective first and second screws (642, 642′), delimited peripherally by respective crests (645) (the first screw 642 and second screw 642′ are equal according to description page 15, lines 19-20); said wear-resistant treatment being present on a helical thrust face of each said first and second screws (642, 642′), on the respective crests (645).

8. The machine according to claim 7, characterised in that said coefficient of compression of said first and second augers (64, 64′) is greater than or equal to 2 and less than or equal to 7 or approximates 2.5.

9. The machine according to claim 1, characterised in that said drainage means (60) are arranged to drain said wet material (MU) so as to feed to said unloading station (40) drained material (MD) containing dry matter in a percentage ranging from at least 55% to 75% or in a percentage ranging from 60% to 70% or in a percentage of 65%.

10. The machine according to claim 7. characterised in that said first/second auger (64) (64′) is conical and carries a first screw (642) (642′) with a variable pitch.

11. The machine according to claim 10, characterized in that said first/second auger (64) (64′) is conical with a diameter increasing linearly between said loading station (30) and said unloading station (40); said first/second screw (642) (642′) having a pitch decreasing or increasing between said loading station (30) and said unloading station (40).

12. The machine according to claim 1, characterised in that said duct (62) comprises at least one plate body (622) having filter means (6240) comprising, by choice or in combination, at least one sheet having a plurality of holes of transverse dimension variable in respective length, at least two coupled sheets with coaxial axisymmetric holes and of a different diameter, a plurality of parallel thin plates distributed at reduced distance ranging from 0.1 mm and 1.00 mm.

13. The machine according to claim 1, characterised in that said wet material (MU) comprises preferably paper mill waste.
